(19) United States
(12) Patent Application Publication
(10) Pub. No.: US 2009/0152754 A1
(43) Pub. Date: Jun. 18, 2009

(54) THERMOPLASTIC ELASTOMER COMPOSITION FOR FOAM INJECTION MOLDING, FOAM BODY, AND PROCESS FOR PRODUCING FOAM BODY

(75) Inventors: Kazuyoshi FUSE, Chiba (JP); Yuya YAMAMOTO, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/327,843

(22) Filed: Dec. 4, 2008

(30) Foreign Application Priority Data
Dec. 12, 2007 (JP) 2007-320558

(51) Int. Cl. B29C 44/02; C08K 5/01

(52) U.S. Cl. 264/51; 521/139

(57) ABSTRACT

A thermoplastic elastomer composition for foam injection molding is provided that includes component (A), component (B), component (C), and component (D) below, relative to 100 parts by weight of component (A), component (B) having a content of 5 to 150 parts by weight, component (C) having a content of 5 to 300 parts by weight, and component (D) having a content of 5 to 150 parts by weight. (A): A hydrogenated product of a block copolymer comprising a block composed of an aromatic vinyl compound-based monomer unit and a block composed of a conjugated diene compound-based monomer unit, the hydrogenated product having a weight-average molecular weight of not more than 200,000, (B): a propylene resin, (C): a mineral oil, and (D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber). There are also provided a foam body formed by foam injection molding of the thermoplastic elastomer composition, a process for producing a foam body that includes a step of preparing the thermoplastic elastomer composition and a step of foam injection molding the thermoplastic elastomer composition, and the use thereof as a composition for foam molding.

### BACKGROUND OF THE INVENTION

1. Field of the Invention

The present invention relates to a thermoplastic elastomer composition for foam injection molding, a foam body, and a process for producing a foam body.

2. Description of the Related Art

Foam bodies used in automobile interior materials, household electrical appliances, furniture, etc. are required to have flexibility, heat resistance, etc., and as such a foam body, a foam body formed by foam injection molding a styrenic thermoplastic elastomer composition comprising a polypropylene resin and a hydrogenated product of a block copolymer comprising a block composed of an aromatic vinyl compound-based monomer unit and a block composed of a conjugated diene compound-based monomer unit has been examined.

For example, JP-A-6-218741 (JP-A denotes a Japanese unexamined patent application publication.) proposes a process for producing a foam body in which molding is carried out by injecting into a mold cavity a foaming styrenic thermoplastic elastomer comprising (a) 100 parts by weight of a styrenic thermoplastic elastomer component having a JIS-A hardness in accordance with JIS-K6301 of 40 to 95 and having a hydrogenated product of a styrene-conjugated diene block copolymer having an average molecular weight of not more than 150,000 as a base, and (b) 0.01 to 10 parts by weight of a foaming agent component, and then foaming by increasing the cavity volume.

Furthermore, JP-A-2006-175825 proposes a composite molding formed by integrally molding a polyolefin-based composite resin layer disposed or injection-molded in a mold with a foamed layer by foam injection molding a foamed layer composition, the foamed layer composition comprising (a) a hydrogenated product of a block copolymer comprising an aromatic vinyl compound block and a conjugated diene compound block and having a weight-average molecular weight of not more than 200,000, (b) a propylene polymer, (c) a softener for rubber, (d) a propylene polymer mixture comprising 30 to 70 wt % of a crystalline propylene polymer and, as the remainder, an amorphous copolymer comprising propylene and ethylene, the foamed layer composition and the foamed layer having the properties that (A) the foamed layer composition has a type A hardness in accordance with JIS-K6253 of not more than 80 and the foamed layer has an ASKER C surface hardness of not more than 75, (B) the foamed layer has a foam expansion ratio of not less than 1.2 times, (C) the foamed layer composition has a melt spreadability of not less than 80 m/min at 170° C. to 190° C., and (D) with regard to a TMA measurement value of the foamed layer composition in accordance with JIS-K7196, the temperature at 0.1 mm deformation is not less than 100° C. and the temperature at 0.5 mm deformation is not less than 120° C.

### BRIEF SUMMARY OF THE INVENTION

However, in the above-mentioned foam body, due to the foamed cells being large or due to the size and shape of the foamed cells being nonuniform, the feel of softness might deteriorate, and the fineness of foamed cells and the uniformity of foamed cells are not fully satisfactory.

In the light of such circumstances, it is an object of the present invention to provide a styrenic thermoplastic elastomer composition for foam injection molding that gives a foam body having foamed cells with excellent fineness and foamed cells with excellent uniformity by foam injection molding, a foam body formed by foam injection molding of the thermoplastic elastomer composition, and a process for producing a foam body by foam injection molding the thermoplastic elastomer composition.

The above object of the present invention has been attained by [1], and [8] to [10] below. They are described below together with [2] to [7], which are preferred embodiments.
[1] A thermoplastic elastomer composition for foam injection molding, the composition comprising component (A), component (B), component (C), and component (D) below, relative to 100 parts by weight of component (A), component (B) having a content of 5 to 150 parts by weight, component (C) having a content of 5 to 300 parts by weight, and component (D) having a content of 5 to 150 parts by weight
(A): a hydrogenated product of a block copolymer comprising a block composed of an aromatic vinyl compound-based monomer unit and a block composed of a conjugated diene compound-based monomer unit, the hydrogenated product having a weight-average molecular weight of not more than 200,000,
(B): a propylene resin,
(C): a mineral oil,
(D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber),
[2] the thermoplastic elastomer composition according to [1], wherein the ethylene-based monomer unit in the ethylene-propylene copolymer rubber of component (D) has a content of 60 to 80 wt %,
[3] the thermoplastic elastomer composition according to [1] or [2], wherein the block composed of the aromatic vinyl compound-based monomer unit has a content of not less than 5:wt %, and not more than 50 wt % relative to 100 wt % of the total amount of the block composed of the aromatic vinyl compound-based monomer unit and the block composed of the conjugated diene compound-based monomer unit of component (A),
[4] the thermoplastic elastomer composition according to any one of [1] to [3], wherein component (A) has a degree of hydrogenation of not less than 50%,
[5] the thermoplastic elastomer composition according to any one of [1] to [4], wherein component (A) has a weight-average molecular weight of not less than 50,000, and not more than 180,000,
[6] the thermoplastic elastomer composition according to any one of [1] to [5], wherein component (B) has a melt flow rate (load 21.18 N, temperature 230° C.) of not less than 0.1 g/10 minutes, and not more than 300 g/10 minutes,
[7] the thermoplastic elastomer composition according to any one of [1] to [6], wherein component (C) has a pour point of not more than 0° C.,
[8] a foam body formed by foam injection molding of the thermoplastic elastomer composition according to any one of [1] to [7],
[9] a process for producing a foam body, comprising the steps of preparing the thermoplastic elastomer composition according to any one of [1] to [7], and foam injection molding the thermoplastic elastomer composition, and
[10] use of the thermoplastic elastomer composition according to any one of [1] to [7] as a composition for foam molding.

### DETAILED DESCRIPTION OF THE INVENTION

The thermoplastic elastomer composition for foam injection molding of the present invention comprises component (A), component (B), component (C), and component (D) below.
(A): A hydrogenated product of a block copolymer comprising a block composed of an aromatic vinyl compound-based monomer unit and a block composed of a conjugated diene compound-based monomer unit, the hydrogenated product having a weight-average molecular weight of not more than 200,000.
(B): A propylene resin.
(C): A mineral oil.
(D): An ethylene-propylene copolymer rubber having a Mooney viscosity (ML₁₊₄, 100° C.) of 20 to 200, an ethylene-based monomer unit (ethylene unit) having a content of 40 to 80 wt % (relative to 100 wt % of the copolymer rubber).

Component (A) used in the present invention is a compound formed by hydrogenating a block copolymer comprising a block composed of an aromatic vinyl compound-based monomer unit (aromatic vinyl compound block) and a block composed of a conjugated diene compound-based monomer unit (conjugated diene compound block). Examples of the aromatic vinyl compound include styrene, α-methylstyrene, o-methylstyrene, m-methylstyrene, p-methylstyrene, 1,3-dimethylstyrene, vinylnaphthalene, and vinylanthracene, and styrene is preferable. With regard to these aromatic vinyl compounds, two or more types thereof may be used. Furthermore, examples of the conjugated diene compound include butadiene, isoprene, 1,3-pentadiene, and 2,3-dimethyl-1,3-butadiene, and butadiene and isoprene are preferable. With regard to these conjugated diene compounds, two or more types thereof may be used.

With regard to the content of the aromatic vinyl compound block and the conjugated diene compound block, from the viewpoint of enhancing the mechanical strength and the heat resistance of a foam body it is preferable for the content of the aromatic vinyl compound block to be not less than 5 wt % and for the content of the conjugated diene compound block to be not more than 95 wt %, and it is more preferable for the content of the aromatic vinyl compound block to be not less than 10 wt % and for the content of the conjugated diene compound block to be not more than 90 wt %. Furthermore, from the viewpoint of enhancing the flexibility of a foam body, it is preferable for the content of the aromatic vinyl compound block to be not more than 50 wt % and for the content of the conjugated diene compound block to be not less than 50 wt %, and it is more preferable for the content of the aromatic vinyl compound block to be not more than 40 wt % and for the content of the conjugated diene compound block to be not less than 60 wt %. Here, the total amount of aromatic vinyl compound block and conjugated diene compound block is defined as 100 wt %. In addition, the content of the aromatic vinyl compound block means the total mount of aromatic vinyl compound blocks; for example, when the block copolymer is an aromatic vinyl compound block-conjugated diene compound block-aromatic vinyl compound block triblock copolymer, the total amount of aromatic vinyl compound blocks is preferably the above content.

The content of each block is the content after hydrogenation.

The block copolymer may be a diblock copolymer having an aromatic vinyl compound-block-conjugated diene compound block structure, or may be a triblock copolymer having an aromatic vinyl compound block-conjugated diene compound block-aromatic vinyl compound block structure.

The hydrogenated product of the block copolymer is one formed by partially or completely hydrogenating the double bonds of a conjugated diene compound-based monomer unit forming the conjugated diene compound block. From the viewpoint of enhancing the weatherability and the heat resistance of a foam body, the degree of hydrogenation, that is, with the amount of double bonds of the conjugated diene compound-based monomer unit of the block copolymer prior to hydrogenation as 100%, among the double bonds the amount of double bonds that are hydrogenated by hydrogenation of the block copolymer, is preferably not less than 50% , more preferably not less than 80%, and preferably not more than 100%.

From the viewpoint of enhancing the fineness of foamed cells and the uniformity of foamed cells, the weight-average molecular weight of the hydrogenated product is not more than 200,000, preferably less than 200,000, more preferably not more than 180,000, yet more preferably not more than 160,000, and particularly preferably not more than 150,000. Furthermore, from the viewpoint of enhancing the mechanical strength of the foam body, it is preferably not less than 50,000, more preferably not less than 90,000. The weight-average molecular weight is a weight-average molecular weight on a polystyrene basis, and is measured by a gel permeation chromatographic (GPC) method.

As an example of a process for producing the hydrogenated product, a block copolymer is produced by a method described in, for example, JP-B-40-23798 (JP-B denotes a Japanese examined patent application publication), and the block copolymer is then hydrogenated by a method described in, for example, JP-B-42-8704, JP-B-43-6636, JP-A-59-133203, or JP-A-60-79005.

A commercial product may be used as the hydrogenated product. Examples thereof include ‘KRATON-G’ (trade name) manufactured by Kraton Polymers LLC, ‘SEPTON’ (trade name) manufactured by Kuraray Co., Ltd., and ‘Tuftec’ (trade name) manufactured by Asahi Kasei Corporation.

Component (B) used in the present invention is a propylene resin, and examples thereof include a propylene homopolymer, and a copolymer of propylene and at least one type of comonomer selected from the comonomer group consisting of ethylene and an α-olefin having 4 to 10 carbons. The copolymer may be a random copolymer or a block copolymer. Specific examples of the copolymer include a propylene-ethylene copolymer, a propylene-1-butene copolymer, a propylene-1-hexene copolymer, a propylene-1-octene copolymer, a propylene-ethylene-1-butene copolymer, and a propylene-ethylene-1-hexene copolymer. Preferred propylene resins are a propylene homopolymer, a propylene-ethylene copolymer, and a propylene-1-butene copolymer.

The content of the propylene-based monomer unit (propylene unit) of a polymer used in the propylene resin is preferably more than 60 wt %, more preferably not less than 80 wt %, and preferably not more than 100 wt %. Here, the polymer is defined as 100 wt %.

The melt flow rate of the propylene resin is preferably 0.1 to 300 g/10 minutes, more preferably 0.5 to 200 g/10 minutes, and yet more preferably 1 to 150 g/10 minutes. The melt flow rate is measured in accordance with JIS K7210 with a load of 21.18 N at a temperature of 230° C.

The propylene resin may be produced by a known polymerization method using as a polymerization catalyst a Ziegler-Nafta catalyst, a metallocene catalyst, etc. Examples of the polymerization method include a solution polymerization method, a bulk polymerization method, a slurry polymerization method, and a gas-phase polymerization method, and they may be employed in a combination of two or more types.

Component (C) used in the present invention is a mineral oil and functions as a softening agent; examples thereof include an aromatic-based mineral oil (aromatic mineral oil), a naphthene-based mineral oil (naphthenic mineral oil), and a paraffin-based mineral oil (paraffinic mineral oil), and it may comprise two or more types thereof. A paraffin-based mineral oil is preferable. Furthermore, the average molecular weight is preferably 300 to 1,500, and the pour point is preferably not more than 0° C.

Component (D) used in the present invention is an ethylene-propylene copolymer rubber, that is, a rubber polymer having an ethylene-based monomer unit (ethylene unit) and a propylene-based monomer unit (propylene unit). The ethylene-propylene copolymer rubber may comprise, as a monomer unit other than an ethylene unit and a propylene unit, for example, a monomer unit based on a non-conjugated diene such as 1,4-hexadiene, dicyclopentadiene, or 5-ethylidene-2-norbornene in a range that does not impair the effect of the present invention.

From the viewpoint of enhancing the fineness of foamed cells, the uniformity of foamed cells, and the mechanical strength of the foam body, the Mooney viscosity (ML₁₊₄ 100° C.) of the ethylene-propylene copolymer rubber at 100° C. is not less than 20, preferably not less than 45, yet more preferably not less than 70, and particularly preferably not less than 80. Furthermore, from the viewpoint of enhancing the molding processability, it is not more than 200, preferably not more than 160, and yet more preferably not more than 120. The Mooney viscosity is measured in accordance with JIS K6300.

From the viewpoint of enhancing the fineness of foamed cells, the uniformity of foamed cells, the mechanical strength of the foam body, and the stability toward heat, oxygen, and light, the content of the ethylene unit of the ethylene-propylene copolymer rubber is not less than 40 wt %, preferably not less than 50 wt %, more preferably not less than 55 wt %, and yet more preferably not less than 60 wt %. Furthermore, the content of the ethylene unit is preferably not more than 80 wt %. Here, the ethylene-propylene copolymer rubber is defined as 100 wt %.

The ethylene-propylene copolymer rubber is produced by a known polymerization method employing an olefin polymerization catalyst. Examples thereof include a slurry polymerization method, a solution polymerization method, a bulk polymerization method, and a gas-phase polymerization method, these methods employing a complex catalyst such as a Ziegler-Natta catalyst, a metallocene catalyst, or a non-metallocene complex.

The thermoplastic elastomer composition of the present invention may comprise various types of additives in a range that does not impair the object of the present invention. Specific examples of the additives include various types of antioxidants such as a phenol-based antioxidant, a phosphorus-based antioxidant, and a sulfur-based antioxidant; various types of thermal stabilizers such as a hindered amine-based thermal stabilizer; various types of UV absorbers such as a benzophenone-based UV absorber, a benzotriazole-based UV absorber, and a benzoate-based UV absorber; various types of antistatic agents such as a nonionic antistatic agent, a cationic antistatic agent, and an anionic antistatic agent; various types of dispersants such as a bisamide-based dispersant, a wax-based dispersant, and an organometallic salt-based dispersant; various types of chlorine scavengers such as a carboxylic acid alkaline earth metal salt-based chlorine scavenger; various types of lubricants such as an amide-based lubricant, a wax-based lubricant, an organometallic salt-based lubricant, and an ester-based lubricant; various types of decomposition agents such as an oxide-based decomposition agent and a hydrotalcite-based decomposition agent; various types of metal deactivators such as a hydrazine-based metal deactivator and an amine-based metal deactivator; various types of flame retardants such as a bromine-containing organic flame retardant, a phosphoric acid-based flame retardant, antimony trioxide, magnesium hydroxide, and red phosphorus; various types of inorganic fillers such as talc, mica, clay, calcium carbonate, aluminum hydroxide, magnesium hydroxide, barium sulfate, glass fiber, carbon fiber, silica, calcium silicate, potassium titanate, and wallastonite; organic fillers; organic pigments; inorganic pigments; inorganic antimicrobial agents; and organic antimicrobial agents.

From the viewpoint of enhancing the heat resistance of a foam body, the amount of propylene resin, which is component (B), combined in the thermoplastic elastomer composition of the present invention is not less than 5 parts by weight, preferably not less than 10 parts by weight, more preferably not less than 20 parts by weight, and particularly preferably not less than 40 parts by weight, relative to 100 parts by weight of component (A). Furthermore, from the viewpoint of enhancing the flexibility of a foam body, it is not more than 150 parts by weight, preferably not more than 120 parts by weight, more preferably not more than 100 parts by weight, and yet more preferably not more than 80 parts by weight.

From the viewpoint of enhancing the molding processability and the flexibility of a foam body, the amount of mineral oil, which is component (C), combined in the thermoplastic elastomer composition of the present invention relative to 100 parts by weight of component (A) is not less than 5 parts by weight, preferably not less than 30 parts by weight, and yet more preferably not less than 50 parts by weight. Furthermore, from the viewpoint of enhancing the bleed resistance and the heat resistance of a foam body, it is not more than 300 parts by weight, preferably not more than 200 parts by weight, more preferably not more than 150 parts by weight, and yet more preferably not more than 100 parts by weight.

From the viewpoint of enhancing the fineness of foamed cells, the uniformity of foamed cells, and the heat resistance, the amount of ethylene-propylene copolymer rubber, which is component (D), combined in the thermoplastic elastomer composition of the present invention relative to 100 parts by weight of component (A) is not less than 5 parts by weight, preferably not less than 10 parts by weight, more preferably not less than 20 parts by weight, and yet more preferably not less than 40 parts by weight. Furthermore, from the viewpoint of enhancing the molding processability, it is not more than 150 parts by weight, preferably not more than 130 parts by weight, more preferably not more than 100 parts by weight, and yet more preferably not more than 80 parts by weight.

The thermoplastic elastomer composition of the present invention is obtained by melt-kneading using a known thermal kneader such as a mixing roll, a kneader, a Banbury mixer, or an extruder the hydrogenated product of component (A), the propylene resin of component (B), the mineral oil of component (C), the ethylene-propylene copolymer rubber of component (D), and another component such as an additive combined as required.

Moreover, when combining the mineral oil, an oil-extended ethylene-propylene copolymer rubber in which a mineral oil is added to an ethylene-propylene copolymer rubber in advance may be used. As a method for combining a mineral oil with an ethylene-propylene copolymer rubber, there can be cited as examples (1) a method in which an ethylene-propylene copolymer rubber and a mineral oil are mechanically kneaded using a kneading machine such as a roll or a Banbury mixer, and (2) a method in which a mineral oil is added to a solution of an ethylene-propylene copolymer rubber, and solvent is subsequently removed by a method such as stream stripping.

The thermoplastic elastomer composition of the present invention is used in foam injection molding and molded into a foam body. In foam injection molding, a cavity of a mold of an injection molding device is filled with a molten thermoplastic elastomer composition having a foaming agent dissolved therein, the molten thermoplastic elastomer composition is foamed within the mold, and the molten thermoplastic elastomer composition is subsequently cooled and solidified, thus giving a foamed molding.

With regard to the foaming agent used in foam injection molding, a known agent such as a chemical foaming agent or a physical foaming agent may be used. With regard to the chemical foaming agent or the physical foaming agent, two or more types thereof may be used in combination. Furthermore, a chemical foaming agent and a physical foaming agent may be used in combination.

Examples of the chemical foaming agent include an inorganic compound and an organic compound, and they may be used in a combination of two or more types. Examples of the inorganic compound include a hydrogen carbonate salt such as sodium hydrogen carbonate, and ammonium carbonate.

Furthermore, examples of the organic compound include a polycarboxylic acid, an azo compound, a sulfone hydrazide compound, a nitroso compound, p-toluenesulfonyl semicarbazide, and an isocyanate compound. Examples of the polycarboxylic acid include citric acid, oxalic acid, fumaric acid, and phthalic acid. Examples of the azo compound include azodicarbonamide (ADCA). Examples of the sulfone hydrazide compound include p-methylurethane benzenesulfonyl hydrazide, 2,4-toluenedisulfonyl hydrazide, and 4,4′-oxybisbenzenesulfonyl hydrazide. Examples of the nitroso compound include dinitrosopentamethylenetetramine (DPT).

Examples of the physical foaming agent include an inert gas and a volatile organic compound such as butane or pentane. As the physical foaming agent, an inert gas is preferable, and examples of the inert gas include carbon dioxide, nitrogen, argon, neon, and helium. Carbon dioxide and nitrogen are more preferable.

The amount of foaming agent used, relative to 100 parts by weight of the thermoplastic elastomer composition, is preferably 0.1 to 20 parts by weight, and more preferably 0.2 to 8 parts by weight. Furthermore, when a chemical foaming agent and a physical foaming agent are used in combination, the amount of chemical foaming agent used is preferably 0.05 to 5 parts by weight relative to 100 parts by weight of the thermoplastic elastomer composition.

As an injection method in foam injection molding, there can be cited as examples a single screw injection method, a multiple screw injection method, a high pressure injection method, a low pressure injection method, and an injection method using a plunger, etc. Furthermore, as an injection method, a method in which an inert gas, which is used as a physical foaming agent, is poured into a cylinder of an injection molding device in a supercritical state is preferable.

As a foaming method in foam injection molding, methods (1), (2), and (3) below can be cited as examples.
(1) A method in which an amount of foaming agent-containing molten thermoplastic elastomer composition that is smaller than the volume of a mold cavity is injected into the mold cavity, and the mold cavity is filled with the molten thermoplastic elastomer composition due to expansion of gas from the foaming agent, thus carrying out foaming.
(2) A method in which an amount of foaming agent-containing molten thermoplastic elastomer composition that fully fills the mold cavity with the foaming agent-containing molten thermoplastic elastomer composition is injected into the mold cavity, and expansion by a portion corresponding to the shrinkage volume of the thermoplastic elastomer composition accompanying cooling is carried out by means of gas from the foaming agent, thus carrying out foaming.
(3) A method in which an amount of foaming agent-containing molten thermoplastic elastomer composition that fully fills the mold cavity with the foaming agent-containing molten thermoplastic elastomer composition is injected into the mold cavity, and a cavity wall face of the mold is subsequently moved back to thus increase the cavity volume, thus making gas from the foaming agent expand and carrying out foaming.

As the foaming method in foam injection molding, a method in which an amount of foaming agent-containing molten thermoplastic elastomer composition that fully fills the mold cavity with the foaming agent-containing molten thermoplastic elastomer composition is injected into the mold cavity (fully-filled method) is preferable.

The foam injection molding may be carried out in a combination with a molding method such as gas-assist molding, melt core molding, insert molding, core back molding, or two-color molding.

A foamed molding obtained using the thermoplastic elastomer composition for foam injection molding of the present invention has excellent fineness of foamed cells and excellent uniformity of foamed cells. Because of this, a foam body has an excellent feel of softness, and is excellent in terms of light weight, rigidity, and impact resistance.

A foamed molding obtained using the thermoplastic elastomer composition for foam injection molding of the present invention is suitably used in automobile interior materials, household electrical appliances, furniture, etc.

In accordance with the present invention, there can be provided a styrenic thermoplastic elastomer composition for foam injection molding that gives a foam body having foamed cells with excellent fineness and foamed cells with excellent uniformity by foam injection molding, a foam body formed by foam injection molding of the thermoplastic elastomer composition, and a process for producing a foam body by foam injection molding the thermoplastic elastomer composition.

### EXAMPLES

The present invention is explained in more detail below by reference to Examples and Comparative Examples.

### I. Methods for Measuring Physical Properties

### (1) Weight-Average Molecular Weight

Measured using a gel permeation chromatographic (GPC) method under conditions 1) to 8) below.
1) Device: Waters 150 C manufactured by Waters
2) Separation column: TOSOH TSK gel GMH6-HT
3) Measurement temperature: 140° C.
4) Carrier: ortho-dichlorobenzene
5) Flow rate: 1.0 mL/min
6) Amount injected: 500 μL
7) Detector: differential refractometer
8) Molecular weight reference material: standard polystyrene

### (2) Melt Flow Rate (MFR)

Measured in accordance with JIS K7210 with a load of 21.18 N at a temperature of 230° C.

(3) Mooney viscosity (ML₁₊₄, 100° C.)

Measured in accordance with JIS K6300 at a test temperature of 100° C.

(4) Ethylene content

Measured by an infrared spectroscopic method.

(5) Fineness and uniformity of foamed cells

A foam body was sectioned, and the section was examined using a microscope (DG-3 digital field microscope, manufactured by Scalar Corporation), and the fineness and uniformity of foamed cells were evaluated as follows.

### Fineness of Foamed Cells

Good: number-average diameter of cells was not more than 500 μm.
Poor: number-average diameter of cells was more than 500 μm.

### Uniformity of Foamed Cells

Good: size and shape of cells were uniform.
Fair: no open cells were observed, but size and shape of cells were nonuniform.
Poor: open cells were observed, and size and shape of cells were nonuniform.

### II. Starting Materials

(1) Hydrogenated Product of styrene-Conjugated diene-styrene Block Copolymer
A-1: hydrogenated product of styrene-isoprene-styrene block copolymer (weight-average molecular weight 129,000, styrene content 13 wt %, degree of hydrogenation 100%)
A-2: hydrogenated product of styrene-isoprene-styrene block copolymer (weight-average molecular weight 126,000, styrene content 18 wt %, degree of hydrogenation 99%)
A-3: hydrogenated product of styrene-butadiene-styrene block copolymer (weight-average molecular weight 101,000, styrene content 30 wt %, degree of hydrogenation 99%)
A-4: hydrogenated product of styrene-butadiene-styrene block copolymer (weight-average molecular weight 320,000, styrene content 33 wt %, degree of hydrogenation 100%)

### (2) Propylene Resin

B-1: NOBRENE HR100EG (trade name) manufactured by Sumitomo Chemical Co., Ltd. (MFR=19 g/10 minutes)
B-2: NOBRENE U501E1 (trade name) manufactured by Sumitomo Chemical Co., Ltd. (MFR=120 g/10 minutes)

### (3) Mineral Oil

C-1: Diana Process Oil PW-100 (trade name) manufactured by Idemitsu Kosan Co., Ltd. (pour point: −15° C.)

### (4) Ethylene-propylene Copolymer Rubber

D-1: Esprene 512P (trade name) manufactured by Sumitomo Chemical Co., Ltd. (ML₁₊₄, 100° C.=90, ethylene content=67 wt %)
D-2: Esprene 222 (trade name) manufactured by Sumitomo Chemical Co., Ltd. (ML₁₊₄, 100° C.=65, ethylene content=52 wt %)
D-3: Esprene 201 (trade name) manufactured by Sumitomo Chemical Co., Ltd. (ML₁₊₄, 100° C.=43, ethylene content=49 wt %)
D-4: TAFMER P-0775 (trade name) manufactured by Mitsui Chemicals, Inc. (ML₁₊₄, 100° C.=70, ethylene content=71 wt %)
D-5: TAFMER P-0275 (trade name) manufactured by Mitsui Chemicals, Inc. (ML₁₊₄, 100° C.=16, ethylene content=71 wt %)

### Example 1

### (Preparation of Thermoplastic Elastomer Composition)

100 parts by weight of the hydrogenated product of a styrene-conjugated diene-styrene block copolymer A-1, 65 parts by weight, relative to 100 parts of A-1, of the propylene resin B-1, 71 parts by weight, relative to 100 parts of A-1, of the mineral oil C-1, 59 parts by weight, relative to 100 parts of A-1, of the ethylene-propylene copolymer rubber D-1 and, relative to 100 parts by weight of the total of A-1, B-1, C-1, and D-1, 0.05 parts by weight of erucamide (NEUTRON S (trade name) manufactured by Nippon Fine Chemical), 0.05 parts by weight of calcium stearate, 0.10 parts by weight of antioxidant IRGANOX 1010 (trade name) manufactured by Ciba Specialties, and 0.05 parts by weight of antioxidant Ultranox 626 (trade name) manufactured by GE Specialty Chemicals were melt-kneaded in a Banbury mixer and then molded into pellets, thus giving thermoplastic elastomer composition pellets.

### (Production of Injection-Foamed Molding)

Foam injection molding was carried out using an ES2550/400HL-MuCell manufactured by ENGEL as an injection molding machine (mold clamp force 400 t) with a mold having a box shape with molding dimensions of 290 mm×370 mm, height 45 mm, thickness 1.5 mm (gate structure: bubble gate, molding central portion). 100 parts by weight of the thermoplastic elastomer composition pellets combined with 1 part by weight of an organic acid salt-based foaming agent master batch (MB3083 (trade name) manufactured by Sankyo Kasei Co., Ltd.) as a chemical foaming agent was supplied to the injection molding machine and melted within a cylinder of the injection molding machine, and carbon dioxide was pressurized to 6 MPa and supplied into the cylinder (amount of carbon dioxide injected: 0.6 parts by weight relative to 100 parts by weight of the thermoplastic elastomer composition). Subsequently, the thermoplastic elastomer composition and the foaming agent were injected at a molding temperature of 210° C. and a mold temperature of 20° C. for an injection time of 2.6 sec to thereby fully fill the cavity of the mold therewith, and they were cooled within the mold cavity. Subsequently, a mold cavity wall face was moved back by 3 mm to thereby increase the inner volume of the cavity, thus carrying out foaming, and cooling and solidification were further carried out, thus giving a foamed molding. The evaluation results are given in Table 1.

### Example 2

The procedure of Example 1 was repeated except that the propylene resin B-2 was used instead of the propylene resin B-1. The evaluation results are given in Table 1.

### Example 3

The procedure of Example 2 was repeated except that the hydrogenated product of a styrene-conjugated diene-styrene block copolymer A-2 was used instead of the hydrogenated product of a styrene-conjugated diene-styrene block copolymer A-1. The evaluation results are given in Table 1.

### Example 4

The procedure of Example 2 was repeated except that the hydrogenated product of a styrene-conjugated diene-styrene block copolymer A-3 was used instead of the hydrogenated product of a styrene-conjugated diene-styrene block copolymer A-1. The evaluation results are given in Table 1.

### Example 5

The procedure of Example 1 was repeated except that the ethylene-propylene copolymer rubber D-2 was used instead of the ethylene-propylene copolymer rubber D-1. The evaluation results are given in Table 1.

### Example 6

The procedure of Example 1 was repeated except that the ethylene-propylene copolymer rubber D-3 was used instead of the ethylene-propylene copolymer rubber D-1. The evaluation results are given in Table 1.

### Example 7

The procedure of Example 1 was repeated except that the ethylene-propylene copolymer rubber D-4 was used instead of the ethylene-propylene copolymer rubber D-1. The evaluation results are given in Table 1.

### Comparative Example 1

The procedure of Example 1 was repeated except that the propylene resin B-1 was used at 41 parts by weight relative to 100 parts by weight of A-1, the mineral oil C-1 was used at 44 parts by weight relative to 100 parts by weight of A-1, and the ethylene-propylene copolymer rubber D-1 was not used. The evaluation results are given in Table 2.

### Comparative Example 2

The procedure of Example 1 was repeated except that 100 parts by weight of the hydrogenated product of a styrene-conjugated diene-styrene block copolymer A-4 was used instead of the hydrogenated product of a styrene-conjugated diene-styrene block copolymer A-1, the propylene resin B-1 was used at 68 parts by weight relative to 100 parts by weight of A-4, the mineral oil C-1 was used at 170 parts by weight relative to 100 parts by weight of A-4, and the ethylene-propylene copolymer rubber D-1 was used at 84 parts by weight relative to 100 parts by weight of A-4. The evaluation results are given in Table 2.

### Comparative Example 3

The procedure of Example 1 was repeated except that 100 parts by weight of the hydrogenated product of a styrene-conjugated diene-styrene block copolymer A-4 was used instead of the hydrogenated product of a styrene-conjugated diene-styrene block copolymer A-1, the propylene resin B-1 was used at 39 parts by weight relative to 100 parts by weight of A-4, the mineral oil C-1 was used at 140 parts by weight relative to 100 parts by weight of A-4, and the ethylene-propylene copolymer rubber D-1 was not used. The evaluation results are given in Table 2.

### Comparative Example 4

The procedure of Example 1 was repeated except that the ethylene-propylene copolymer rubber D-5 was used instead of the ethylene-propylene copolymer rubber D-1. The evaluation results are given in Table 2.

TABLE 1

| | | Ex. 1 | Ex. 2 | Ex. 3 | Ex. 4 | Ex. 5 | Ex. 6 | Ex. 7 |
|---|---|---|---|---|---|---|---|---|
| Composition | | | | | | | | |
| A-1 | Parts by weight | 100 | 100 | — | — | 100 | 100 | 100 |
| A-2 | Parts by weight | — | — | 100 | — | — | — | — |
| A-3 | Parts by weight | — | — | — | 100 | — | — | — |
| B-1 | Parts by weight | 65 | — | — | — | 65 | 65 | 65 |
| B-2 | Parts by weight | — | 65 | 65 | 65 | — | — | — |
| C-1 | Parts by weight | 71 | 71 | 71 | 71 | 71 | 71 | 71 |
| D-1 | Parts by weight | 59 | 59 | 59 | 59 | — | — | — |
| D-2 | Parts by weight | — | — | — | — | 59 | — | — |
| D-3 | Parts by weight | — | — | — | — | — | 59 | — |
| D-4 | Parts by weight | — | — | — | — | — | — | 59 |
| Evaluation results | | | | | | | | |
| Fineness | — | Good | Good | Good | Good | Good | Good | Good |
| Uniformity | — | Good | Good | Good | Good | Fair | Fair | Good to Fair |

TABLE 2

| | | Comp. | Comp. | Comp. | |
|---|---|---|---|---|---|
| | | Ex. 1 | Ex. 2 | Ex. 3 | Comp. Ex. 4 |
| Composition | | | | | |
| A-1 | Parts by weight | 100 | — | — | 100 |
| A-4 | Parts by weight | — | 100 | 100 | — |
| B-1 | Parts by weight | 41 | 68 | 39 | 65 |
| C-1 | Parts by weight | 44 | 170 | 140 | 71 |
| D-1 | Parts by weight | — | 84 | — | — |
| D-5 | Parts by weight | — | — | — | 59 |
| Evaluation results | | | | | |
| Fineness | — | Good | Poor | Poor | Fair |
| Uniformity | — | Poor | Poor | Poor | Poor |

1. A thermoplastic elastomer composition for foam injection molding, the composition comprising component (A), component (B), component (C), and component (D) below, relative to 100 parts by weight of component (A), component (B) having a content of 5 to 150 parts by weight, component (C) having a content of 5 to 300 parts by weight, and component (D) having a content of 5 to 150 parts by weight
(A): a hydrogenated product of a block copolymer comprising a block composed of an aromatic vinyl compound-based monomer unit and a block composed of a conjugated diene compound-based monomer unit, the hydrogenated product having a weight-average molecular weight of not more than 200,000,
(B): a propylene resin,
(C): a mineral oil,
(D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber).

2. The thermoplastic elastomer composition according to claim 1, wherein the ethylene-based monomer unit in the ethylene-propylene copolymer rubber of component (D) has a content of 60 to 80 wt %.

3. The thermoplastic elastomer composition according to claim 1, wherein the block composed of the aromatic vinyl compound-based monomer unit has a content of not less than 5 wt %, and not more than 50 wt % relative to 100 wt % of the total amount of the block composed of the aromatic vinyl compound-based monomer unit and the block composed of the conjugated diene compound-based monomer unit of component (A).

4. The thermoplastic elastomer composition according to claim 1, wherein component (A) has a degree of hydrogenation of not less than 50%.

5. The thermoplastic elastomer composition according to claim 1, wherein component (A) has a weight-average molecular weight of not less than 50,000, and not more than 180,000.

6. The thermoplastic elastomer composition according to claim 1, wherein component (B) has a melt flow rate (load 21.18 N, temperature 230° C.) of not less than 0.1 g/10 minutes, and not more than 300 g/10 minutes.

7. The thermoplastic elastomer composition according to claim 1, wherein component (C) has a pour point of not more than 0° C.

8. A foam body formed by foam injection molding of the thermoplastic elastomer composition according to claim 1.

9. A process for producing a foam body, comprising the steps of:
preparing the thermoplastic elastomer composition according to claim 1; and
foam injection molding the thermoplastic elastomer composition.

10. Use of the thermoplastic elastomer composition according to claim 1 as a composition for foam molding.
